(19) United States
(12) Patent Application Publication
(10) Pub. No.: US 2009/0129048 A1
(43) Pub. Date: May 21, 2009

(54) Brightness adjustable keyboard illuminating module of electronic device

(75) Inventor: Chun-Chi Wang, Tucheng City (TW)

Correspondence Address: QUINTERO LAW OFFICE, PC, 2210 MAIN STREET, SUITE 200, SANTA MONICA, CA, 90405, US

(73) Assignee: Mitac Technology Corp., HsinChu (TW)

(21) Appl. No.: 11/984,584

(22) Filed: Nov. 20, 2007

(51) Int. Cl. H05B 37/02; H01H 9/00

(52) U.S. Cl. 362/23; 315/291

(57) ABSTRACT

A brightness adjustable keyboard illuminating module of an electronic device includes a controlling unit, a voltage regulating unit, and a projection lamp unit. The controlling unit is used for receiving a brightness adjusting command to generate a pulse width modulation (PWM) signal according to the brightness adjusting command. The voltage regulating unit receives the PWM signal and regulates a voltage of an output driving signal according to a duty cycle of the PWM signal. The projection lamp unit receives the driving signal and projects light in response to the voltage of an output driving signal, to the keyboard of the electronic device.

### BACKGROUND OF THE INVENTION

1. Field of the Invention

The present invention relates to an illuminating module, and more particularly to a keyboard illuminating module of an electronic device.

2. Related Art

As the rapid development of computers, it has become an essential demand for modern people to carry computers along with them. In order to meet such a trend, computer manufacturers are making portable computers into even smaller ones, i.e., laptops with a size similar to books. A laptop has functions almost the same as that of the desktop computer, but can be placed into a suitcase or a bag that can be taken along, so as to satisfy the businessmen's requirements that he/she can use the computer anytime and anywhere.

As the laptop is small and light, it is frequently used in meetings, symposiums, or presentations, for presenting data. Generally, the data to be presented are projected onto a large screen. However, the laptop user may still need to operate the computer while projecting the data onto a large screen when the environmental light is insufficient, it is possible that the required key cannot be found or the incorrect key is pressed, which is quite inconvenient. Therefore, an electronic device with a keyboard illumination function is now available, which provides an auxiliary light device to solve the aforementioned problems. The auxiliary light device includes a case, a light guiding element, and a light emitting element. The case has a keyboard accommodation portion for accommodating a keyboard, and has an opening in at least one side of the keyboard accommodation portion. The light guiding element is disposed within the case and adjacent to the opening. At least a part of lights emitted from the light guide element is incident on at least one side of the keyboard via the opening. The light emitting element is disposed on at least one side of the light guide element.

Moreover, a portable computer with an auxiliary light device has been proposed, which provides an auxiliary light to solve the aforementioned problems. The auxiliary light device emits lights towards a keyboard of the portable computer at a normal operation position, such that marks or notations printed on the keys and positions of the keys can be seen clearly when the keyboard is operated in a dark environment. The portable computer with auxiliary light device includes a conventional portable computer using an LCD or other devices to serve as a covering panel for a display, and an auxiliary light device having at least one light emitting device, such as a tungsten bulb, disposed above the covering panel. The incident angle for the light emitting device at least can be adjusted towards a single direction, so as to keep the incident angle in the direction towards the keyboard of the portable computer.

Though the above designs can solve the lighting requirement problem when using the keyboard, but when the environment has different brightness conditions, preferable illumination effect can not be obtained if the keyboard is still illuminated with the same brightness light. Therefore, it has become a problem need to be solved by researchers for providing a keyboard illuminating module that can adjust the brightness.

### SUMMARY OF THE INVENTION

Accordingly, the present invention provides a keyboard illuminating module of an electronic device, which uses a pulse width modulation (PWM) signal together with a low-cost voltage control circuit to adjust brightness of a light source output from the keyboard illuminating module, so as to achieve preferred lighting effects.

A keyboard illuminating module of an electronic device according to the present invention includes a controlling unit, a voltage regulating unit, and a projection lamp unit. The controlling unit is used for receiving a brightness adjusting command, and generating a pulse width modulation (PWM) signal according to a brightness adjusting command. The voltage regulating unit is electrically connected to the controlling unit, for receiving the PWM signal and controlling a voltage of an output driving signal according to a duty cycle of the PWM signal. And the projection lamp unit is electrically connected to the voltage regulating unit for receiving the driving signal and then projecting light in response to the voltage, such that the projection lamp unit projects light onto the keyboard of the electronic device.

Moreover, another embodiment of the present invention provides a keyboard illuminating module of an electronic device, which includes a controlling unit and a projection lamp unit. The controlling unit is used for receiving a brightness adjusting data, and converting the brightness adjusting data into an analog driving signal and outputting the analog driving signal. The projection lamp unit is electrically connected to the controlling unit for receiving the analog driving signal and projecting light according to the analog driving signal, such that the projection lamp unit projects light onto the keyboard of the electronic device.

In the keyboard illuminating module of an electronic device, through utilizing the features of the controlling unit of the electronic device having pulse width modulation or digital to analog conversion functions, and selecting a low-cost voltage regulating unit, the keyboard illuminating module is provided with an additional function of brightness adjustment, besides the basic ON/OFF functions similar to that of the keyboard illuminating modules in the art. Thus, when the external environment has different brightness conditions, preferable illumination can be achieved by adjusting the brightness for illuminating the keyboard, so as to improve the operation quality of the electronic device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1A is a system block diagram of a first embodiment of the present invention;

FIG. 1B is a system block diagram of a second embodiment of the present invention; and

FIG. 2 is a circuit diagram of the first embodiment of the present invention.

### DETAILED DESCRIPTION OF THE INVENTION

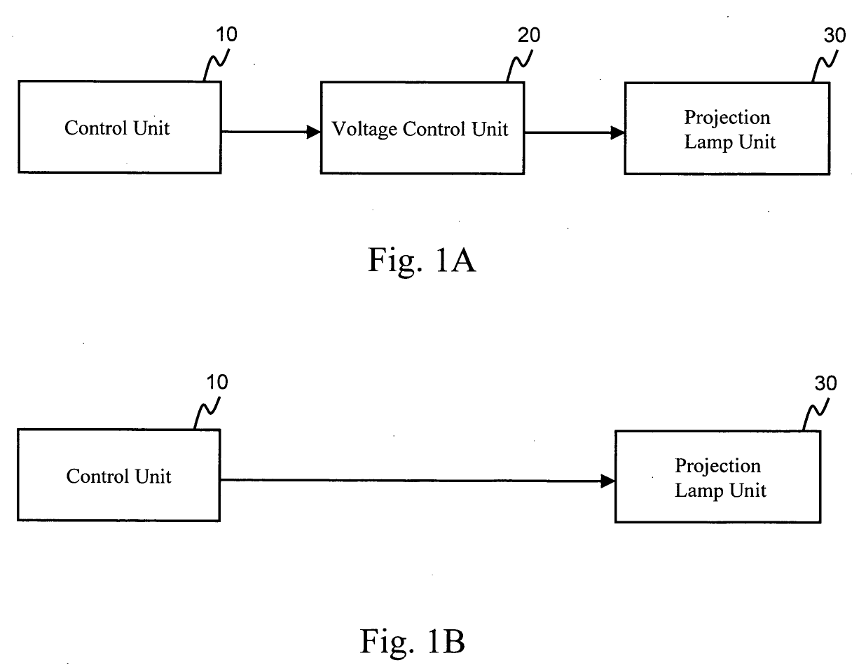

FIG. 1A is a system block diagram of a first embodiment of the present invention. As shown in FIG. 1A, the brightness adjustable keyboard illuminating module of an electronic device of the present invention includes a controlling unit 10, a voltage regulating unit 20, and a projection lamp unit 30.

The controlling unit 10 is electrically connected to the voltage regulating unit 20, and receives a brightness adjusting command. The brightness adjusting command is, for example, sent from application software that offers a brightness adjusting function in an operating system, or generated by hardware circuits according to an operation of a user.

Then, the controlling unit 10 generates and outputs a pulse width modulation (PWM) signal according to the brightness adjusting command. The controlling unit 10 can be, for example, an embedded controller (EC), a keyboard controller (KBC), or a PWM integrated circuit (PWM IC).

In addition, the controlling unit 10 can be further connected to a circuit having photonic sensor. According to a pre-established environment brightness adjusting comparison table of sensed brightness value to output PMW signal, the controlling unit 10 outputs the PWM signal to the voltage regulating unit 20 according to the environment brightness adjusting comparison table, so as to perform voltage control operations. Thus, the electronic device can automatically adjust the brightness for illuminating the keyboard according to the external environment brightness.

The voltage regulating unit 20 is electrically connected to the controlling unit 10, receives the PWM signal output from the controlling unit 10, and then regulates a voltage of an output driving signal according to a duty cycle of the PWM signal. For example, when the duty cycle of the PWM signal is increased to become ten times of the original duty cycle of the PWM signal, the voltage of the driving signal output from the voltage regulating unit 20 is reduced to 1/10 of the original output voltage. In other words, the duty cycle of the PWM signal is an inversing proportion to the voltage of the output driving signal. The voltage regulating unit 20 can be, for example, an integrator circuit having a resistor, a capacitor, and an operational amplifier.

Alternatively, when the duty cycle of the PWM signal is increased to become ten times of the original duty cycle of the PWM signal, the voltage of the driving signal output from the voltage regulating unit 20 is also increased to ten times of the original output voltage. In other words, the duty cycle of the PWM signal is directly proportional to the voltage of the output driving signal. The voltage regulating unit 20 can be, for example, an integrator circuit formed by a resistor, a capacitor, and an operational amplifier.

The projection lamp unit 30 is electrically connected to the voltage regulating unit 20, receives the driving signal output from the voltage regulating unit 20, and then projects light in response to the voltage of the driving signal, such that the projection lamp unit 30 projects the light onto the keyboard of the electronic device. For example, when the received voltage of the driving signal is high, the projection lamp unit 30 projects light with higher brightness. When the received voltage of the driving signal is low, the projection lamp unit 30 projects light with lower brightness. The projection lamp unit 30 can be, for example, an LED of white or other colors, or a cold cathode fluorescent lamp (CCFL), and the projection lamp unit 30 can be disposed in the keyboard having transparent structure, or disposed at an appropriate position on the electronic device.

FIG. 1B is a system block diagram of a second embodiment of the present invention. Referring to FIG. 1B, the brightness adjustable keyboard illuminating module of the electronic device of the present invention includes a controlling unit 10 and a projection lamp unit 30.

The controlling unit 10 is electrically connected to the projection lamp unit 30, and receives a brightness adjusting data. The brightness adjusting data can be, for example, sent from an application that offers a brightness adjusting function in an operating system, or generated by hardware circuits according to a user's operation result. Then, the controlling unit 10 converts the brightness adjusting data into an analog driving signal and outputs the analog driving signal. The controlling unit 10 can be, for example, an embedded controller (EC), a keyboard controller (KBC), or a digital to analog converter (DAC) integrated circuit.

In addition, the controlling unit 10 can be further connected to a circuit having photonic sensor. According to a pre-established environment brightness adjusting comparison table of sensed brightness values to output PMW signal, the controlling unit 10 outputs the analog driving signal to the voltage regulating unit 20 according to the environment brightness adjusting comparison table, so as to perform voltage control operations. Thus, the electronic device can automatically adjust the brightness for illuminating the keyboard according to the external environment brightness.

The projection lamp unit 30 is electrically connected to the controlling unit 10, receives the analog driving signal output from the controlling unit 10, and then projects light in response to the analog driving signal onto the keyboard of the electronic device. For example, when the value of the received analog driving signal is high, the projection lamp unit 30 projects light with higher brightness. When the value of the received analog driving signal is low, the projection lamp unit 30 projects light with lower brightness. The projection lamp unit 30 can be, for example, an LED of white or other colors, or a CCFL, and the projection lamp unit 30 can be disposed in the keyboard having transparent structure, or disposed at an appropriate position on the electronic device.

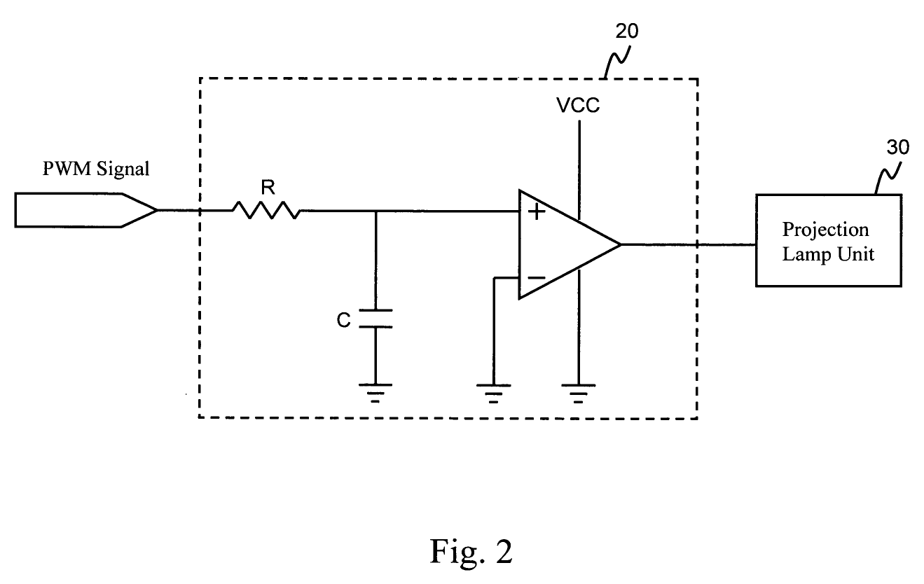

FIG. 2 is a circuit diagram of the first embodiment of the present invention. As shown in FIG. 2, the keyboard illuminating module of an electronic device of the present invention includes a controlling unit 10 (not shown in FIG. 2), a voltage regulating unit 20, and a projection lamp unit 30. The connection relationship of the circuit is described below.

A first end of a resistor R is electrically connected to the controlling unit 10, and receives the PWM signal. A second end of the resistor R is electrically connected to a first end of a capacitor C and a non-inverting input end of an operational amplifier OP. A second end of the capacitor C and an inverting input end of the OP are electrically connected to a grounding connection. An output end of the OP is electrically connected to the projection lamp unit 30. The resistor R, the capacitor C, and the operational amplifier OP form the integrator circuit.

The operating principles of the circuit are described as follows.

When the PWM signal is input to the voltage regulating unit 20 at a first duty cycle, due to the characteristics of the integrator circuit, the voltage regulating unit 20 outputs a driving signal at a first voltage to the projection lamp unit 30 at this time, such that the projection lamp unit 30 projects light with a first brightness. When the PWM signal is output to the voltage regulating unit 20 at a second duty cycle instead of the first duty cycle, due to the characteristics of the integrator circuit, the voltage regulating unit 20 is altered to output the driving signal of a second voltage value instead of the first voltage value to the projection lamp unit 30, such that the projection lamp unit 30 projects light with second brightness. Therefore, by changing the value of the PWM signal with different duty cycles, the brightness of the projection lamp unit 30 can be adjusted.

To summarize, in the keyboard illuminating module of an electronic device of the present invention, by means of utilizing the features of the controlling unit in the electronic device having the pulse width modulation or digital to analog conversion functions, and selecting a low-cost voltage regulating unit, the keyboard illuminating module is provided with an additional function of brightness adjustment, besides the basic ON/OFF functions similar to that of the keyboard illuminating modules in the art. Thus, when the external environment has different brightness conditions, desirable illumination can be achieved by adjusting the brightness for illuminating the keyboard, so as to improve the operation quality of the electronic device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A brightness adjustable keyboard illuminating module of an electronic device, comprising:
a controlling unit, for receiving a brightness adjusting command to generate a pulse width modulation signal according to the brightness adjusting command;
a voltage regulating unit, electrically connected to the controlling unit, for receiving the pulse width modulation signal, and then regulating a voltage of an output driving signal according to a duty cycle of the pulse width modulation signal; and
a projection lamp unit, electrically connected to the voltage regulating unit, for receiving the driving signal, and projecting light in response to the voltage of the driving signal, and projecting the light onto the keyboard of the electronic device.

2. The brightness adjustable keyboard illuminating module of an electronic device as claimed in claim 1, wherein the voltage regulating unit is an integrator circuit having a resistor, a capacitor, and an operational amplifier.

3. The brightness adjustable keyboard illuminating module of an electronic device as claimed in claim 2, wherein a first end of the resistor is electrically connected to the controlling unit, a second end of the resistor is electrically connected to a first end of the capacitor and a non-inverting input end of the operational amplifier, a second end of the capacitor and an inverting input end of the operational amplifier are electrically connected to a grounding connection, and an output end of the operational amplifier is electrically connected to the projection lamp unit.

4. The brightness adjustable keyboard illuminating module of an electronic device as claimed in claim 1, wherein the controlling unit is an embedded controller or a keyboard controller.

5. The brightness adjustable keyboard illuminating module of an electronic device as claimed in claim 1, wherein the controlling unit is a pulse width modulation integrated circuit.

6. The brightness adjustable keyboard illuminating module of an electronic device as claimed in claim 1, wherein the controlling unit further connected to a circuit having photonic sensor.

7. The brightness adjustable keyboard illuminating module of an electronic device as claimed in claim 6, wherein the controlling unit automatically outputs the pulse width modulation signal to the voltage regulating unit according to a pre-established environment brightness adjusting comparison table of sensed brightness value and the pulse width modulation signal.

8. A brightness adjustable keyboard illuminating module of an electronic device, comprising:
a controlling unit, for receiving a brightness adjusting data, and converting the brightness adjusting data into an analog driving signal and outputting the analog driving signal; and
a projection lamp unit, electrically connected to the controlling unit, for receiving the analog driving signal and then projecting light in response to the analog driving signal, and projecting the light onto the keyboard of the electronic device.

9. The brightness adjustable keyboard illuminating module of an electronic device as claimed in claim 8, wherein the controlling unit is an embedded controller or a keyboard controller.

10. The brightness adjustable keyboard illuminating module of an electronic device as claimed in claim 8, wherein the controlling unit is a digital to analog converting integrated circuit.

11. The brightness adjustable keyboard illuminating module of an electronic device as claimed in claim 8, wherein the controlling unit further connected to a circuit having photonic sensor.

12. The brightness adjustable keyboard illuminating module of an electronic device as claimed in claim 11, wherein the controlling unit automatically outputs the pulse width modulation signal to the projection lamp unit according to a pre-established environment brightness adjusting comparison table of sensed brightness value and the pulse width modulation signal.
